(19) United States
(12) Patent Application Publication
(10) Pub. No.: US 2026/0136105 A1
(43) Pub. Date: May 14, 2026

(54) IMAGE SENSOR DEVICE

(71) Applicant: Samsung Electronics Co., Ltd., Suwon-si (KR)

(72) Inventors: Hyunyup Kwak, Suwon-si (KR); Dongbum Choi, Suwon-si (KR); Joohyun Lee, Suwon-si (KR); Jongseong Choi, Suwon-si (KR)

(21) Appl. No.: 19/238,052

(22) Filed: Jun. 13, 2025

(30) Foreign Application Priority Data
Nov. 11, 2024 (KR) 10-2024-0159379

(51) Int. Cl. H04N 23/72; H04N 23/67; H04N 23/73; H04N 23/741; H04N 23/76; H04N 23/84; H04N 25/57

(52) U.S. Cl. CPC H04N 23/72; H04N 23/675; H04N 23/73; H04N 23/741; H04N 23/76; H04N 23/84; H04N 25/57

(57) ABSTRACT

An image sensor device is provided. The image sensor device includes: an image sensor generating raw data; an image signal processor including a High Dynamic Range (HDR) circuit generating one piece of HDR data using the raw data, and processing the one piece of HDR data to generate image data; and a feature extraction circuit extracting feature data from each of the plurality of pieces of raw data and the piece of HDR data, and the image sensor and the image signal processor receive a control signal determined from the feature data, and adjust at least one of an autoexposure function, an autofocus function, or an auto white balance function, in response to the control signal.

### CROSS-REFERENCE TO RELATED APPLICATION(S)

This application claims benefit of priority to Korean Patent Application No. 10-2024-0159379 filed on Nov. 11, 2024, in the Korean Intellectual Property Office, the disclosure of which is incorporated herein by reference in its entirety.

### BACKGROUND

An image sensor device is configured to receive light and generate image data, and may include an image sensor including a plurality of pixels generating electric signals in response to light and peripheral circuits driving the plurality of pixels to generate raw data, and a signal processor processing the raw data to generate image data. The image sensor device provides an automatic shooting mode for the convenience of the user, and may automatically determine most of the settings that need to be selected for imaging, in the automatic shooting mode, based on feature data extracted from the raw data. Recently, a High Dynamic Range (HDR) function having an improved dynamic range of images has been applied to various image sensor devices. In related art, however, the settings in the automatic shooting mode can be applied only with feature data extracted from the raw data before HDR processing, and the image quality may not be sufficiently improved in the automatic shooting mode.

### SUMMARY

An aspect of the present disclosure is to provide an image sensor device with improved 3A (Autoexposure, Auto White Balance and Autofocus) performance.

An image sensor device according to an example implementation of the present disclosure includes: an image sensor configured to generate raw data; an image signal processor including a High Dynamic Range (HDR) circuit configured to generate one piece of HDR data using the raw data, and process the HDR data to generate image data; and a feature extraction module configured to extract feature data from the raw data and the HDR data, and the image sensor and the image signal processor receive a control signal determined based on the feature data, and adjust at least one of an autoexposure function, an autofocus function, or an auto white balance function, in response to the control signal.

A system according to an example implementation includes: an image sensor configured to image a subject and generate raw data; an image signal processor configured to convert the raw data into image data; a driver including camera control software configured to drive the image sensor and the image signal processor, in response to a imaging command generated by a user interface driving a camera application; and a feature extraction module configured to extract feature data from each of the raw data and HDR data generated by executing HDR processing on the raw data by the image signal processor, and the camera control software sets a 3A (Autoexposure, Autofocus and Auto White Balance) function by referring to the feature data.

An image sensor device according to an example implementation includes: an image sensor configured to generate raw data; an image signal processor connected to the image sensor via a sensor interface, and configured to execute HDR processing on the raw data to generate HDR data of the same domain as the raw data; and a feature extraction module configured to acquire feature data necessary for setting the 3A function from the HDR data.

According to an example implementation of the present disclosure, feature data may be extracted from each piece of raw data generated by an image sensor and HDR data generated by executing HDR processing on the raw data, based on which the 3A function may be controlled. The 3A function by referring to the feature data extracted from the HDR data after executing the HDR processing together with the feature data extracted from the raw data may be set and controlled, thereby improving the quality of the image data generated by executing the HDR processing.

Advantages and effects of the present application are not limited to the foregoing content and may be more easily understood in the process of describing a specific example implementation of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic block diagram of an image sensor device according to an example implementation of the present disclosure;

FIGS. 2 and 3 are block diagrams schematically illustrating an image sensor device according to an example implementation of the present disclosure;

FIG. 4A is a circuit diagram schematically illustrating a pixel array included in an image sensor according to an example implementation of the present disclosure;

FIG. 4B is a view schematically illustrating raw data generated by an image sensor according to an example implementation of the present disclosure;

FIG. 4C and FIG. 4D are views illustrating a method to obtain feature data from raw data according to an example implementation of the present disclosure;

FIG. 5 is a view illustrating an operation of an image sensor device according to an example implementation of the present disclosure;

FIGS. 6 to 8 are views illustrating an operation of an image sensor device according to an example implementation of the present disclosure;

FIGS. 9 to 12 are views illustrating an operation of an image sensor device according to an example implementation of the present disclosure;

FIG. 13 is a view illustrating an operation of an image sensor device according to an example implementation of the present disclosure; and

FIG. 14 is a view illustrating an operation of an image sensor device according to an example implementation of the present disclosure.

### DETAILED DESCRIPTION

Hereinafter, example implementations of the present disclosure will be described with reference to the accompanying drawings.

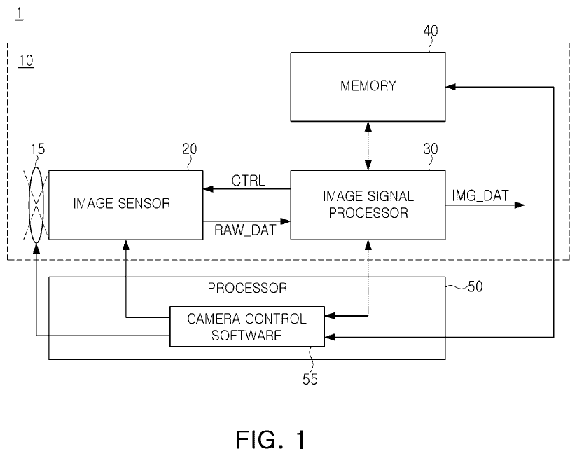

FIG. 1 is a schematic block diagram of an image sensor device according to an example implementation of the present disclosure.

Referring to FIG. 1, an image sensor device 10 according to an example implementation of the present disclosure may include an image sensor 20, an image signal processor 30, and a memory 40. The image sensor device 10 may be included in one system 1 together with a processor 50, and, for example, the system 1 may be a camera device, a smartphone, a tablet PC, an automotive device, or the like.

The image sensor 20 is a sensor configured to convert light passing through a lens unit 15 into a pixel signal, which is an electrical signal, and may include a pixel array including a plurality of pixels generating charges in response to light, and a logic circuit driving the pixel array to obtain a pixel signal converting light. Each of the plurality of pixels may include at least one photodiode generating charges in response to light, and a pixel circuit converting charges generated by the photodiode into an electrical signal. The logic circuit may obtain a pixel signal from the electric signal output by each of the plurality of pixels, and may generate raw data RAW_DAT as a pixel signal and transmit the raw data RAW_DAT to the image signal processor 30. The logic circuit may drive the pixel array in response to a control signal CTRL transmitted by the image signal processor 30.

The image signal processor 30 may process the raw data RAW_DAT and may generate image data IMG_DAT. For example, the raw data RAW_DAT may be data including a plurality of image pixels arranged in the same form as a form in which a plurality of pixels are arranged in a pixel array. For example, when the plurality of pixels are arranged in a Bayer pattern in the pixel array, the plurality of image pixels included in the raw data RAW_DAT may also be arranged in the Bayer pattern. Each of the plurality of image pixels included in the raw data RAW_DAT may include data corresponding to one color, and a color arrangement of the plurality of image pixels may match a color arrangement of the plurality of pixels included in the pixel array. Accordingly, the color arrangement of the plurality of image pixels included in the raw data RAW_DAT may be determined by the color arrangement of the plurality of pixels included in the pixel array.

The image signal processor 30 may process the raw data RAW_DAT and may generate the image data IMG_DAT. The image data IMG_DAT may be data capable of being displayed on a display device. The plurality of image pixels included in the image data IMG_DAT may include 3-channel data defined as RGB/YUV, or the like. Accordingly, each of the plurality of image pixels included in the image data IMG_DAT may include data corresponding to at least two or more colors.

The image signal processor 30 may use various image processing techniques to convert the raw data RAW_DAT into the image data IMG_DAT. For example, the image signal processor 30 may execute image processing such as dead pixel correction, lens shading correction, and white balance gain adjustment on the raw data RAW_DAT, and may then execute DeMosaicing processing, thus generating image data IMG_DAT.

In an example implementation, the image sensor device 10 may support the 3A function. The 3A function is a function of automatically setting an exposure, a white balance, a focus, or the like, of the image sensor device 10, and may include an Autoexposure (AE) function, an Auto White Balance (AWB) function, and an Autofocus (AF) function.

When the 3A function is activated in the image sensor device 10, the image signal processor 30 may set and optimize the AE function, the AWB function, and the AF function by referring to the raw data RAW_DAT received from the image sensor 20. For example, the image signal processor 30 may extract feature data such as a red-green-blue-yellow (RGBY) histogram from the raw data RAW_DAT, and may adjust the 3A function of the image sensor device 10 based on the extracted feature data.

According to an example implementation, the image signal processor 30 may use the memory 40 in a process of extracting and processing the feature data. The image signal processor 30 may store data in the memory 40 or read data stored in the memory 40 in a Direct Memory Access (DMA) manner.

An operation of setting and optimizing the 3A function of the image sensor device 10 by referring to the feature data extracted from the raw data RAW_DAT by the image signal processor 30 may be executed by camera control software 55 driven by the processor 50. For example, the camera control software 55 may adjust the exposure time and gain of the image sensor 20, a position and aperture value of the lens unit 15, and a white balance gain value of the image signal processor 30, by referring to the feature data.

In an example implementation, when a High Dynamic Range (HDR) function of the image sensor device 10 is activated, the image sensor 20 may generate a plurality of pieces of raw data RAW_DAT under different operating conditions. For example, the image sensor 20 may generate first raw data in which an image of a subject is captured at a first exposure time with respect to the same subject, and second raw data in which an image of a subject is captured at a second exposure time, different from the first exposure time.

The image signal processor 30 may generate one piece of HDR data having an improved dynamic range, by executing HDR processing for synthesizing the first raw data and the second raw data. For example, the HDR data may be data of the same domain as the raw data RAW_DAT. The expression that the HDR data and the raw data RAW_DAT have the same domain may be understood as denoting that the plurality of image pixels included in each of the raw data RAW_DAT and the HDR data have the same color arrangement as the pixels included in the pixel array of the image sensor 20. The image signal processor 30 may process the HDR data to generate the image data IMG_DAT. Accordingly, the image data IMG_DAT may have a relatively excellent dynamic range as compared to the raw data RAW_DAT.

In an example implementation of the present disclosure, when the HDR function and the 3A function of the image sensor device 10 are activated at the same time, the image signal processor 30 may extract feature data from the raw data RAW_DAT received from the image sensor 20 and the HDR data on which the HDR processing is completed. The camera control software 55 may set the 3A function of the image sensor device 10 by referring to the feature data extracted from the raw data RAW_DAT and the feature data extracted from the HDR data together. Accordingly, the 3A function may be set in the image sensor device 10 so that the image signal processor 30 may be optimized for the image data IMG_DAT generated by executing the HDR processing on the raw data RAW_DAT, and the quality of the image data IMG_DAT may be improved.

In an example implementation illustrated in FIG. 1, the image signal processor 30 is illustrated as being included in the image sensor device 10 together with the image sensor 20, but the example implementation is not necessarily limited to such a form. For example, the image signal processor 30 may be mounted in the processor 50, and according to an example implementation, the memory 40 may also be mounted in the processor 50.

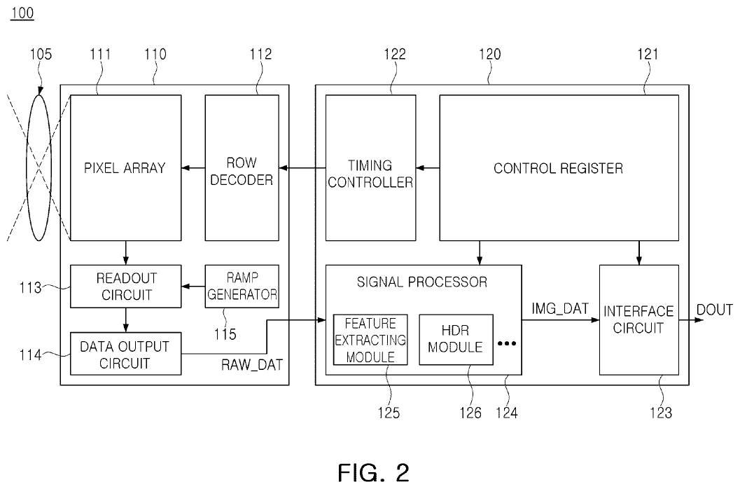

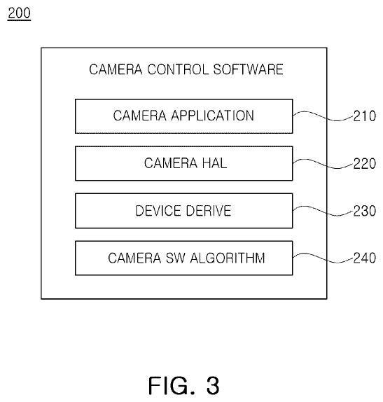

FIGS. 2 and 3 are block diagrams simply illustrating an image sensor device according to an example implementation of the present disclosure.

First, referring to FIG. 2, an image sensor device 100 according to an example implementation of the present disclosure may include a lens unit 105, an image sensor 110, and an image signal processor 120. The image sensor 110 may include a pixel array 111 and peripheral circuits 112 to 115, and the pixel array 111 may include a plurality of pixel regions disposed in an array form along a plurality of rows and a plurality of columns. A photoelectric conversion element such as a photodiode generating charges in response to light may be disposed in each of the plurality of pixel regions, and the photodiode may be connected to a pixel circuit generating and outputting an electric signal corresponding to the charges.

The peripheral circuits 112 to 115 may include circuits for controlling the pixel array 111. For example, the peripheral circuits 112 to 115 may include a row decoder 112, a readout circuit 113, a data output circuit 114, and a ramp generator 115. The peripheral circuits 112 to 115 may operate in response to a control command, for example, a timing control signal, transmitted by a timing controller 122 of the image signal processor 120. The row decoder 112 may drive the pixel array 111 in units of row lines. For example, the row decoder 112 may input switch control signals for controlling an on/off state of each transistor included in the pixel circuit to the pixel array 111 in units of row lines.

Among the pixels, pixels disposed in the same position in a row direction (a horizontal direction in FIG. 2) may share the same column line. In an example implementation, the readout circuit 113 may simultaneously receive signals from two or more pixels selected by the row decoder 112 through the column lines. For example, the readout circuit 113 may read a reset voltage and a signal voltage from each of the pixels, and the signal voltage may be a voltage in which charges generated by the photodiodes of each of the pixels are reflected in the reset voltage.

The readout circuit 113 may include a plurality of correlated dual samplers and a plurality of counters, and the correlated dual samplers may be connected to the pixels through the column lines. For example, one correlated dual sampler and one counter may be connected to one column line. The correlated dual samplers may read voltages from pixels connected to a row line selected by the row decoder 112 through the column lines. One of the input terminals of each of the correlated dual samplers may be connected to the column lines, and the other input terminal may receive a ramp voltage from the ramp generator 115.

The output terminals of each of the correlated dual samplers may be connected to counters, and the counters may generate a digital pixel signal by counting the time during which an output of each of the correlated dual samplers is maintained at a specific voltage. For example, the counter may convert the output of the correlated dual sampler into a digital pixel signal by counting the time during which the ramp voltage input to the correlated dual sampler is higher than a voltage of the column line. The data output circuit 114 may include a memory such as a latch and a buffer circuit for temporarily storing the digital pixel signal, and may output the raw data RAW_DAT including the digital pixel signal to the image signal processor 120. For example, the raw data RAW_DAT may include a plurality of image pixels, and a color arrangement of the plurality of image pixels may be determined by a color arrangement of color filters arranged along a plurality of pixel regions in the pixel array 111.

An operation of the image sensor 110 may be controlled by the timing controller 122 of the image signal processor 120. The timing controller 122 may control the operation timing of the image sensor 110 in response to a command received from the control register 121. For example, an exposure time during which each of a plurality of pixels arranged in the pixel array 111 is exposed to light by the timing controller 122 may be changed. Meanwhile, a signal processor 124 may receive the raw data RAW_DAT from the data output circuit 114 and may execute image processing on the raw data RAW_DAT to generate the image data IMG_DAT.

For example, the image data IMG_DAT generated by the signal processor 124 may be data including a plurality of image pixels, and may have a predetermined frame rate. According to an example implementation, the data of each of the plurality of image pixels included in the image data IMG_DAT may include information on two or more colors, and may be, for example, 3-channel RGB data. An interface circuit 123 may transmit output data DOUT including the image data IMG_DAT to the outside using a predetermined protocol, for example, a Mobile Industry Processor Interface (MIPI) interface.

The image sensor device 100 may provide a 3A function of automatically optimizing main settings affecting the quality of the image data IMG_DAT, for the convenience of a user and/or for improving the quality of the image data IMG_DAT. When the 3A function is activated, a feature extraction module 125 included in the signal processor 124 may extract feature data such as RGBY histogram and brightness data from raw data RAW_DAT. The feature extraction module can also be referred to as a feature extraction circuit in the present disclosure.

The processor included in the system such as the image sensor device 100 may control at least one of the lens unit 105, the image sensor 110, and the image signal processor 120, by referring to the feature data acquired by the feature extraction module 125, and may set and optimize the 3A function. For example, the camera control software mounted on the processor may adjust the brightness of the image data IMG_DAT by adjusting an aperture value of the lens unit 105, the exposure time during which the plurality of pixels in the image sensor 110 are exposed to light, and the like. Additionally, the camera control software may adjust the white balance affecting a color tone of the image data IMG_DAT by adjusting a white balance gain value of the signal processor 124.

Referring to FIG. 2, the image signal processor 120 of the image sensor device 100 according to an example implementation of the present disclosure may include an HDR module 126 executing the HDR processing. For example, the HDR module 126 may synthesize a plurality of pieces of raw data RAW_DAT generated under different imaging conditions to generate one piece of HDR data. The HDR data may be data of the same domain as the plurality of pieces of raw data RAW_DAT. For example, similar to the plurality of pieces of raw data RAW_DAT, the color arrangement of the plurality of image pixels included in the HDR data may be determined by the color arrangement of the color filters arranged along the plurality of pixel regions in the pixel array 111. When each of the plurality of pieces of raw data RAW_DAT is Bayer data, the HDR data may also be Bayer data.

In an example implementation of the present disclosure, the feature extraction module 125 may acquire feature data from the HDR data generated by the HDR module 126. For example, the feature extraction module 125 may extract the feature data from each of the plurality of pieces of raw data RAW_DAT before executing the HDR processing and the HDR data after executing the HDR processing. Accordingly, the camera control software may set the 3A function to a value optimized for improving the quality of the image data IMG_DAT.

FIG. 3 may be a view simply illustrating a camera control software 200 controlling the image sensor device 100. Referring to FIG. 3, the camera control software 200 may include a camera application 210 driven on the user interface level, a camera hardware abstraction layer (HAL) 220 driven on the operating system level, a device driver 230, and a camera software algorithm 240. As described above with reference to FIG. 1, the camera control software 200 may be driven within the processor, and according to an example implementation, the image signal processor 120 may be mounted within the processor.

The camera application 210 may execute and manage the image sensor device 100. When the camera function is executed in a system equipped with the image sensor device 100, a command for outputting a preview image to a display device, or the like, may be generated in the camera application 210. The camera application 210 may be driven on a user interface level, and the control command generated in the user interface may be input to the image sensor device 100 through the camera HAL 220 and the device driver 230.

The camera HAL 220 may provide hardware abstraction, and may hide complex hardware architecture. The device driver 230 may drive hardware components included in the image sensor device 100, such as an actuator for adjusting a focal length of the lens unit 105, and may also provide communication between the hardware components of the image sensor device 100 and the processor. For example, when the user adjusts a zoom ratio through a camera application executed on the user interface level, the zoom ratio of the lens unit 105 may be changed by the camera HAL 220 and the device driver 230.

The camera software algorithm 240 may control an operation of the image sensor device 100 in real time, and for example, the 3A function may be set by the camera software algorithm 240. When the 3A function is activated, the camera software algorithm 240 may receive feature data acquired from the raw data RAW_DAT and the HDR data by the feature extraction module 125 of the image signal processor 120. The camera software algorithm 240 may control the operation of the image sensor device 100 by referring to the feature data, and as an example, hardware components included in the image sensor device 100 may be controlled through the device driver 230.

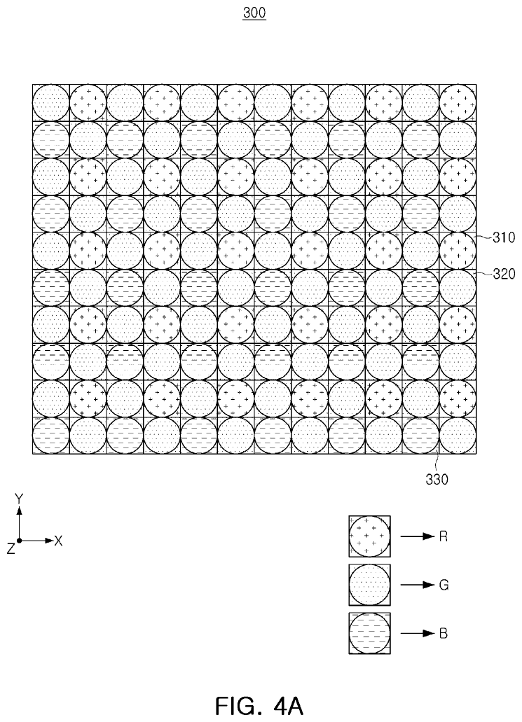

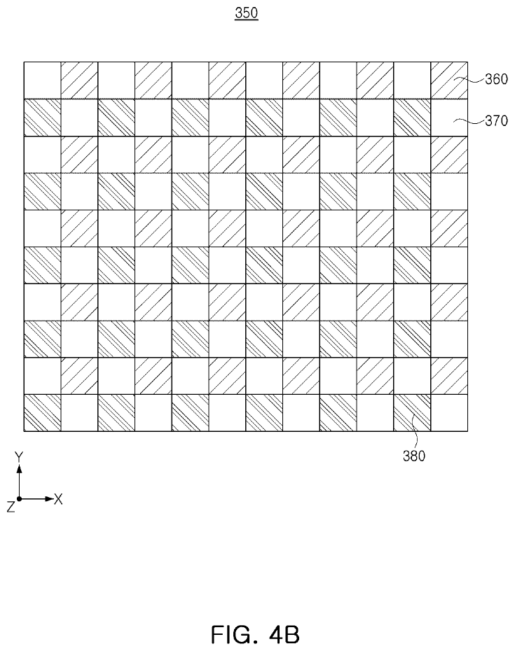

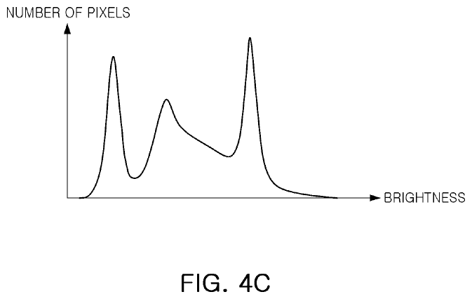

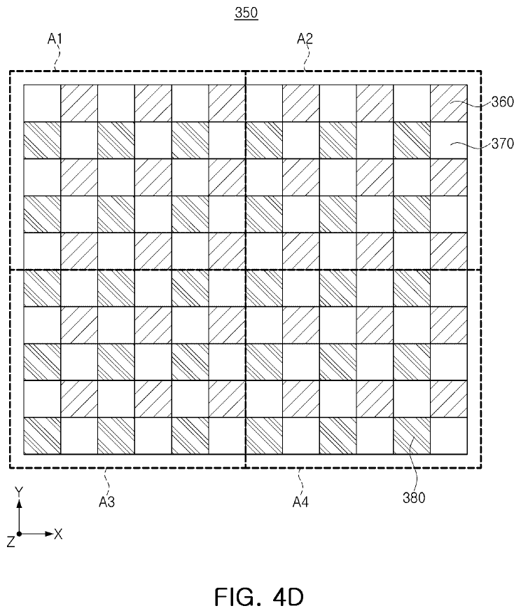

FIG. 4A is a circuit diagram simply illustrating a pixel array included in an image sensor according to an example implementation of the present disclosure.

Referring to FIG. 4A, a pixel array 300 of the image sensor according to an example implementation of the present disclosure may include a plurality of pixel regions 310, 320 and 330 arranged in a first direction (X-axis direction) and a second direction (Y-axis direction). In an example implementation illustrated in FIG. 4A, color filters may be arranged along the plurality of pixel regions 310, 320 and 330. For example, the pixel array 300 may include red pixel regions 310, green pixel regions 320, and blue pixel regions 330. Each of the red pixel regions 310 may include a red color filter, each of the green pixel regions 320 may include a green color filter, and each of the blue pixel regions 330 may include a blue color filter.

However, according to example implementations, the color filters of the pixel regions 310, 320 and 330 included in the pixel array 300 may be implemented in a more diverse manner. For example, at least some of the green pixel regions 320 may be replaced with white pixel regions. The white pixel regions may not include a color filter selectively passing light of a specific color. Alternatively, at least some of the green pixel regions 320 may include a yellow color filter passing yellow light instead of a green color filter.

FIG. 4B is a simple diagram illustrating raw data generated by an image sensor according to an example implementation of the present disclosure.

FIG. 4B may be an example of raw data 350 generated by the image sensor, and the raw data 350 may include a plurality of image pixels 360, 370 and 380. The plurality of image pixels 360, 370 and 380 may be arranged in the first direction and the second direction, similar to the pixel regions 310, 320 and 330 arranged in the pixel array 300.

In an example implementation, the plurality of image pixels 360, 370 and 380 may correspond to the pixel regions 310, 320 and 330. Accordingly, each of the plurality of image pixels 360, 370 and 380 may express one color among red, green, and blue, and the raw data 350 may be generated in a Bayer data format. When the pixel array 300 includes color filters in a pattern other than the Bayer pattern, the plurality of image pixels 360, 370 and 380 included in the raw data 350 may also have a color arrangement according to the pattern of the color filters included in the pixel array 300.

When the raw data 350 is generated, the feature extraction module of the image signal processor may extract feature data from the raw data 350. The feature data may be used for the purpose of optimizing the 3A function. For example, in order to optimize the AE function, which is one of the 3A functions, the feature extraction module may acquire an RGBY histogram of the raw data 350 and brightness data of each of a plurality of regions defined in the raw data 350 as feature data. Hereinafter, this will be described in more detail with reference to FIGS. 4C and 4D together.

FIG. 4C may be a diagram exemplarily illustrating an RGBY histogram acquired by a feature extraction module from the raw data 350. In an example implementation, the feature extraction module may extract histograms for each of red, green, blue, and luminance from the raw data 350. FIG. 4C may be an exemplarily illustrating a histogram extracted from the raw data 350 for one of the colors red, green, and blue.

Since each of the image pixels 360, 370 and 380 included in the raw data 350 represents one color among red, green, and blue, the histogram illustrated in FIG. 4C may represent the brightness distribution of one type of image pixels, among the image pixels 360, 370 and 380. For example, when the histogram of FIG. 4C is a histogram for the red color, it may be determined that among the red image pixels 360 included in the raw data 350, relatively bright image pixels and relatively dark image pixels may be more than the image pixels of medium brightness.

FIG. 4D may be a view illustrating other feature data that the feature extraction module may acquire from the raw data 350. Referring to FIG. 4D, the feature extraction module may divide the raw data 350 into a plurality of regions A1 to A4, and may extract the average brightness, or the like, of the image pixels 360, 370 and 380 disposed in each of the plurality of regions A1 to A4 as feature data. In the implementation illustrated in FIG. 4D, each of the plurality of regions A1 to A4 is illustrated as having a square shape, but the number of the plurality of regions A1 to A4 and the shape of each may vary depending on an example implementation. For example, each of the plurality of regions A1 to A4 may have a shape different from a square, and some of the plurality of regions A1 to A4 may overlap each other and share some of the image pixels 360, 370 and 380.

The feature extraction module may extract feature data not only from the raw data 350, but also from HDR data generated by executing the HDR processing the raw data. For example, the feature extraction module may acquire feature data from each of first raw data generated by exposing the plurality of pixels 310, 320 and 330 to light during a first exposure time by the image sensor, second raw data generated by exposing the plurality of pixels 310, 320 and 330 to light during a second exposure time different from the first exposure time, and the HDR data generated by synthesizing the first raw data and the second raw data by the HDR module.

The image signal processor may transmit the feature data acquired from the raw data 350 and the HDR data to the camera control software. The camera control software may be driven by the image signal processor or a processor implemented separately from the image signal processor. The camera control software may optimize the 3A function of the image sensor by referring to the feature data acquired from the raw data 350 and the HDR data.

For example, as a result of referencing the RGBY histogram extracted from the HDR data, when it is determined that the brightness of the image pixels included in the HDR data is excessively bright, the camera control software may transmit a control signal shortening the exposure time of the image sensor to the image sensor. Conversely, when it is determined that the brightness of the image pixels included in the HDR data is excessively dark, the camera control software may transmit a control signal increasing the exposure time of the image sensor to the image sensor.

Assuming that the image sensor generates the first raw data and the second raw data in a multiple exposure manner, each of the first exposure time and the second exposure time of the image sensor may be determined by the camera control software. Alternatively, according to an example implementation, the image sensor may set the first exposure time and the second exposure time at a predetermined ratio by referring to the control signal received from the camera control software.

As described above, in an example implementation of the present disclosure, the image signal processor may extract feature data from not only the raw data 350 before executing the HDR processing but also the HDR data after executing the HDR processing, and may optimize the 3A function of the image sensor device based thereon. The 3A function by additionally referencing the feature data extracted from the HDR data after executing the HDR processing may be optimized to effectively improve the quality of the image data provided to the user.

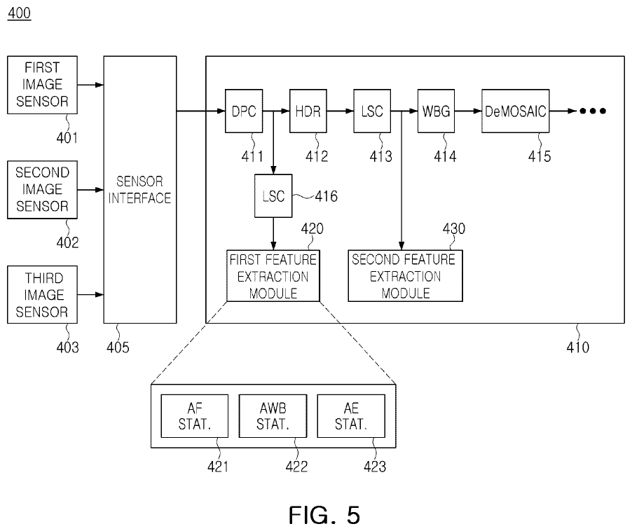

FIG. 5 is a view illustrating an operation of the image sensor device according to an example implementation of the present disclosure.

Referring to FIG. 5, an image sensor device 400 according to an example implementation of the present disclosure may include a plurality of image sensors 401 to 403, a sensor interface 405, and an image signal processor 410. According to an example implementation, the image sensor device 400 may further include an output interface for transmitting image data generated by the image signal processor 410 to a processor, and a memory capable of storing data.

The plurality of image sensors 401 to 403 may have different specifications, and may be connected to the image signal processor 410 through the sensor interface 405. For example, the plurality of image sensors 401 to 403 may have different specifications, such as resolution, wide angle, and zoom ratio. According to an example implementation, at least one of the plurality of image sensors 401 to 403 may be a sensor measuring a distance to a subject or generating a depth map.

When a camera function is activated in a system including the image sensor device 400 and an imaging operation is executed in at least one of the plurality of image sensors 401 to 403, the raw data generated by imaging the subject by at least one of the plurality of image sensors 401 to 403 may be transmitted to the image signal processor 410 through the sensor interface 405. The image signal processor 410 may perform image processing on the raw data and may convert the raw data into image data. The image signal processor 410 may be packaged with the plurality of image sensors 401 to 403 as a single sensor device, or may be included in a processor configured to controlling a system including the plurality of image sensors 401 to 403, for example, a System On Chip (SOC), an application processor, or the like.

In an example implementation illustrated in FIG. 5, the image signal processor 410 may include a dead pixel correction (DPC) circuit 411 correcting dead pixels included in raw data. The dead pixel correction circuit 411 may determine a significantly dark or bright pixel as compared to other neighboring image pixels, among the image pixels included in the raw data, as a dead pixel, which is a type of defective pixel, and may correct the pixel value of the pixel.

The raw data for which the dead pixel correction work is completed may be subjected to HDR processing in a HDR circuit 412. For example, the HDR processing may be an operation of generating one piece of HDR data by synthesizing at least one of the plurality of image sensors 401 to 403 by imaging a subject in a state of setting different exposure times. Alternatively, the HDR processing may be an operation of generating HDR data by performing the HDR processing on one raw data. The HDR circuit 412 may generate HDR data by performing the HDR processing on the raw data, and the HDR data may be data in the same domain as the raw data.

Then, a lens shading correction (LSC) operation for correcting lens shading of the HDR data, a white balance gain (WBG) adjustment operation, and the like, may be executed. A lens shading correction circuit 413 may correct lens shading in which a region near a center of the HDR data appears brighter due to a lens. For example, the lens shading correction operation may be executed in a manner of assigning a greater weight to each pixel value of image pixels as a distance from the center of the HDR data increases.

A white balance gain adjustment circuit 414 may adjust values of some colors, among color channels included in HDR data. For example, since a value of a green channel may generally appear large in the HDR data, the white balance gain adjustment circuit 414 may naturally adjust a color tone of the HDR data by correcting values of red and blue channels.

A DeMosaic circuit 415 may perform a DeMosaic operation of converting the HDR data in which each image pixel represents a single color such as red, green, and blue, into image data. By the DeMosaic operation, the HDR data may be converted into image data, and each image pixel included in the image data may include multi-channel data having information related to two or more colors. According to an example implementation, the image signal processor 410 may further perform a post-processing operation, such as a gamma correction operation or a sharpness correction operation, on the image data generated by the DeMosaic operation.

Referring to FIG. 5, a lens shading correction circuit 416 that separately corrects lens shading, with respect to the raw data on which the dead pixel correction operation is completed, may be further included in the image signal processor 410. The lens shading correction circuit 416 may correct the lens shading of the raw data in a manner identical or similar to that of the lens shading correction circuit 413 correcting the lens shading of the HDR data. The raw data in which the lens shading is corrected may be input to a first feature extraction module 420.

The first feature extraction module 420 may acquire a plurality of feature data 421 to 423 from the raw data. According to an example implementation, the first feature extraction module 420 may include a plurality of sub-feature extraction modules. For example, when a first image sensor 401 generates a plurality of pieces of raw data in a multiple exposure manner, a plurality of sub-feature extraction modules included in the first feature extraction module 420 may extract the feature data 421 to 423 from the plurality of pieces of raw data.

For example, the first image sensor 401 may generate the first raw data in a state of setting the first exposure time, and may generate the second raw data in a state of setting the second exposure time shorter than the first exposure time. The first feature extraction module 420 may include a first sub-feature extraction module extracting the feature data 421 to 423 from the first raw data, and a second sub-feature extraction module extracting the feature data 421 to 423 from the second raw data. However, according to an example implementation, a method in which one first feature extraction module 420 sequentially receives the first raw data and the second raw data and extracts the feature data 421 to 423 of each of the first raw data and the second raw data is also possible.

For example, the feature data 421 to 423 may include AE STAT 421, AWB STAT 422, and AF STAT 423. The feature data 421 to 423 may be used to optimize the 3A function, and may include AE feature data 421 used to optimize the autoexposure function, AWB feature data 422 used to optimize the auto white balance function, and AF feature data 423 used to optimize the autofocus function.

For example, the first feature extraction module 420 may extract the AF feature data 423 from the raw data to control the autofocus function, among the 3A functions, using a contrast detection method. The AE feature data 421 may be feature data extracted from the raw data to control the autoexposure function, and the AWB feature data 422 may be feature data extracted from the raw data to control the auto white balance function. In an example implementation, the AE feature data 421 and/or the AWB feature data 422 may include an RGBY histogram.

In an example implementation, the AF feature data 423 may include sharpness of a region in which the subject is determined to be located in the raw data, or sharpness of a target region selected by the user in an imaging operation. The AE feature data 421 may include brightness calculated from a plurality of regions defined in the raw data as described above with reference to FIG. 4D.

Meanwhile, the image signal processor 410 may include a second feature extraction module 430 extracting the feature data from HDR data for which lens shading is corrected. A type of feature data that the second feature extraction module 430 extracts from the HDR data may be the same as that of the feature data 421 to 423 that the first feature extraction module 420 extracts from the raw data. For example, the second feature extraction module 430 may extract the AE feature data 421, the AWB feature data 422, and the AF framing data 423 from the HDR data.

The feature data acquired by the first feature extraction module 420 and the second feature extraction module 430 may be transmitted to the camera control software. The camera control software may optimize the 3A function of an image sensor imaging the subject and generating raw data, among the plurality of image sensors 401 to 403, by referring to the feature data. The feature data acquired from the HDR data after performing the HDR processing by the HDR circuit 412 may be utilized for optimization of the 3A function, so that the 3A function of the image sensor may be optimized in a manner in which the image signal processor 410 may improve the quality of the image data generated by performing image processing on the raw data.

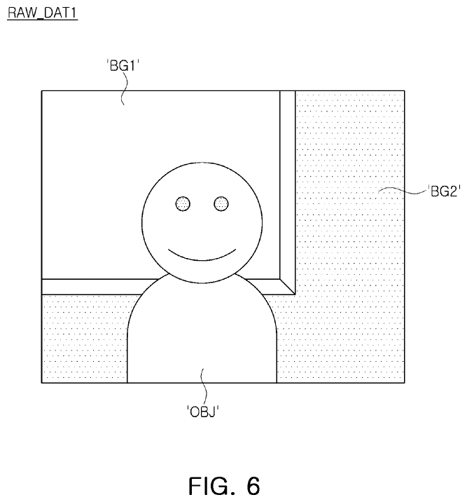

FIGS. 6 to 8 are views illustrating an operation of an image sensor device according to an example implementation of the present disclosure.

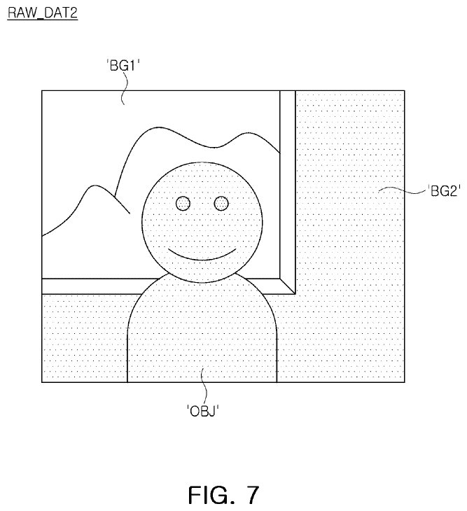

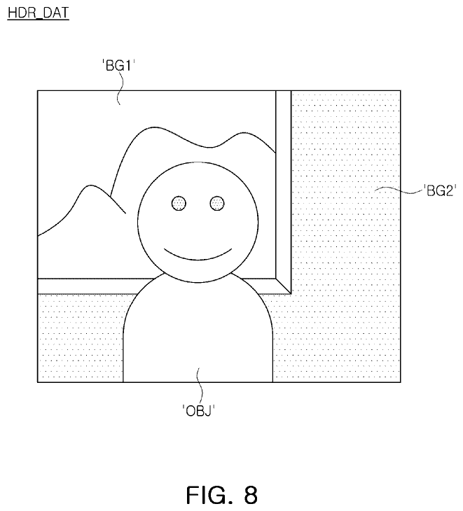

FIGS. 6 and 7 may be views simply illustrating raw data RAW_DAT1 and RAW_DAT2 generated by an image sensor of an image sensor device by imaging the same subject OBJ, and FIG. 8 may be a view simply illustrating HDR data HDR_DAT generated by performing the HDR processing of synthesizing the raw data RAW_DAT1 and RAW_DAT2.

In an example implementation described with reference to FIGS. 6 to 8, a scene to be captured by an image sensor device may be a scene requiring a high dynamic range. As illustrated in FIGS. 6 to 8, a first background region BG1 in which an outdoor landscape is displayed may have very high brightness due to sunlight. On the other hand, a second background region BG2 in which an indoor space is displayed may have relatively dark brightness. An image of the subject OBJ such as a person existing in an indoor space may be captured in a backlit scene due to the first background region BG1.

The first raw data RAW_DAT1 illustrated in FIG. 6 may be data generated by imaging an image of a scene by the image sensor in a state in which the first exposure time is set to be relatively long. Accordingly, in the first raw data RAW_DAT1, the subject OBJ existing in the indoor space and the second background region BG2 in which the indoor space is displayed may be accurately expressed, while the first background region BG1 having high brightness may not be accurately expressed. For example, as illustrated in FIG. 6, the first background region BG1 may not express detailed information, and may be expressed as a single significantly bright region.

The second raw data RAW_DAT2 illustrated in FIG. 7 may be data generated by the image sensor imaging an image of the scene in a state in which the second exposure time is set to be shorter than the first exposure time. Accordingly, in the second raw data RAW_DAT2, the detailed information of the first background region BG1 having high brightness may be accurately expressed. On the other hand, the subject OBJ existing in the indoor space and the second background region BG2 in which the indoor space is displayed may be expressed significantly darkly, and accordingly, the detailed information of the subject OBJ and the indoor space may not be expressed, or the subject OBJ and the indoor space may not be accurately distinguished from each other.

The image signal processor may execute the HDR processing to synthesize the first raw data RAW_DAT1 and the second raw data RAW_DAT2, thus generating one piece of HDR data HDR_DAT. Referring to FIG. 8, in the HDR data HDR_DAT, the first background region BG1, the second background region BG2, and the subject OBJ may all be accurately expressed. For example, the second background region BG2 and the subject OBJ may be selected from the first raw data RAW_DAT1, and the first background region BG1 may be selected from the second raw data RAW_DAT2 to configure one piece of HDR data HDR_DAT, so that the first background region BG1, the second background region BG2, and the subject OBJ may all be accurately expressed.

Referring again to FIG. 5 described above, the first feature extraction module 420 may acquire feature data from each of the first raw data RAW_DAT1 and the second raw data RAW_DAT2, and the second feature extraction module 430 may acquire feature data from the HDR data HDR_DAT. The camera control software controlling the image sensor device may optimize the 3A function by referring to the feature data. For example, the camera control software may adjust an aperture value of a lens portion disposed in a movement path of light entering the image sensor, the exposure time of the image sensor, a position and a size of a region to be focused on the image sensor, and a gain obtained by applying the image signal processor to a white balance gain adjustment operation, by referring to the feature data. Accordingly, the 3A function of the image sensor device may be optimized so that the quality of HDR data generated after executing the HDR processing may be effectively improved.

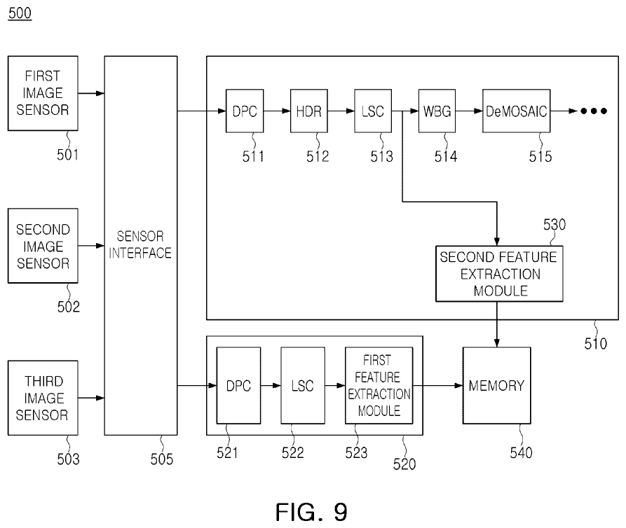

FIGS. 9 to 12 are drawings provided to explain the operation of the image sensor device according to an example implementation of the present disclosure.

First, referring to FIG. 9, an image sensor device 500 according to an example implementation of the present disclosure may include a plurality of image sensors 501 to 503, a sensor interface 505, and an image signal processor 510. As described above with reference to FIG. 5, the image sensor device 500 may further include an output interface for transmitting image data generated by the image signal processor 510 to a processor, and a memory capable of storing data.

The plurality of image sensors 501 to 503 may have different specifications and may be connected to the image signal processor 510 through the sensor interface 505. When a camera function is activated and an imaging operation is executed in the system including the image sensor device 500, at least one of the plurality of image sensors 501 to 503 captures an image of a subject and generated raw data may be transmitted to the image signal processor 510 through the sensor interface 505. The image signal processor 510 may convert the raw data into image data by performing image processing.

The image signal processor 510 may perform dead pixel correction on the raw data and may then perform HDR processing in an HDR circuit 512, thus generating HDR data. For example, the HDR data may be Bayer data, such as the raw data. Then, lens shading correction, white balance gain adjustment, and the like, may be performed on the HDR data, and DeMosaicing may be performed to convert the HDR data into image data, which is RGB data. The image signal processor 510 may further perform post-processing operations, such as gamma correction and sharpness correction, on the image data.

In an example implementation illustrated in FIG. 9, a first feature extraction module 523 extracting feature data from raw data may be implemented separately from the image signal processor 510. The first feature extraction module 523 may be included in a sub-processor 520 implemented as hardware separate from the image signal processor 510. The sub-processor 520 may receive raw data from at least one of the plurality of image sensors 501 to 503 through the sensor interface 505, and may include a dead pixel correction circuit 521 correcting a dead pixel of the raw data and a lens shading correction circuit 522 correcting lens shading of the raw data. The first feature extraction module 523 may extract first feature data from the raw data, the lens shading of which is corrected. The first feature data acquired by the first feature extraction module 523 may be stored in a memory 540.

Meanwhile, a second feature extraction module 530 extracting the feature data from the HDR data may be implemented in the image signal processor 510. The second feature data acquired from the HDR data by the second feature extraction module 530 may be stored in the memory 540. The camera control software may read the first feature data and the second feature data stored in the memory 540 and use the first feature data and the second feature data to optimize the 3A function of the image sensor device.

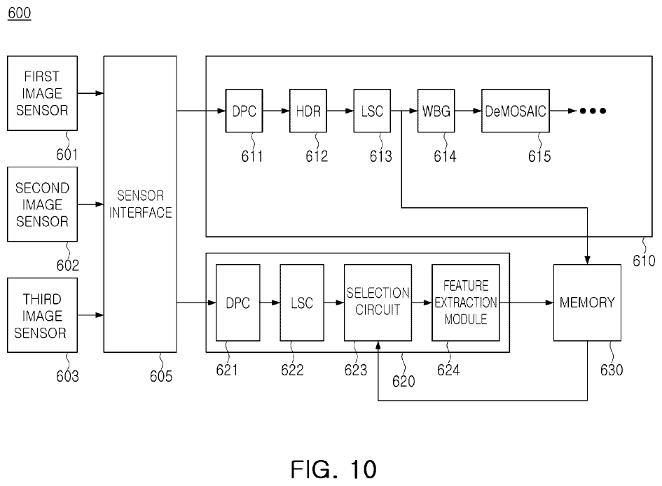

Next, referring to FIG. 10, an image sensor device 600 according to an example implementation of the present disclosure may include a plurality of image sensors 601 to 603, a sensor interface 605, and an image signal processor 610. The image signal processor 610 may perform image processing on raw data generated by at least one of the plurality of image sensors 601 to 603, thus generating image data. The image processing process of the image signal processor 610 may be similar to that described above with reference to FIG. 9.

Referring to FIG. 10, the feature extraction module 624 extracting feature data from HDR data generated by performing HDR processing on the raw data by the raw data and an HDR circuit 612 may not be included in the image signal processor 610. Instead, in an example implementation illustrated in FIG. 10, the feature extraction module 624 may be included in a sub-processor 620 implemented separately from the image signal processor 610.

The sub-processor 620 may receive the raw data from at least one of the plurality of image sensors 601 to 603 through the sensor interface 605, and may correct a dead pixel and lens shading of the raw data. The feature extraction module 624 may extract first feature data from the raw data, the lens shading of which is corrected, and the first feature data may be stored in a memory 630.

Meanwhile, in an example implementation illustrated in FIG. 10, the feature data of HDR data may also be extracted by the feature extraction module 624 of the sub-processor 620. Referring to FIG. 10, the sub-processor 620 may include a selection circuit 623 connected to a front end of the feature extraction module 624. The selection circuit 623 may select one of the raw data in which the lens shading is corrected and the HDR data for which the HDR processing is performed, and may input the selected one to the feature extraction module 624. When the HDR data is provided from the selection circuit 623 to the feature extraction module 624, the feature extraction module 624 may generate second feature data based on the HDR data and store the second feature data in the memory 630.

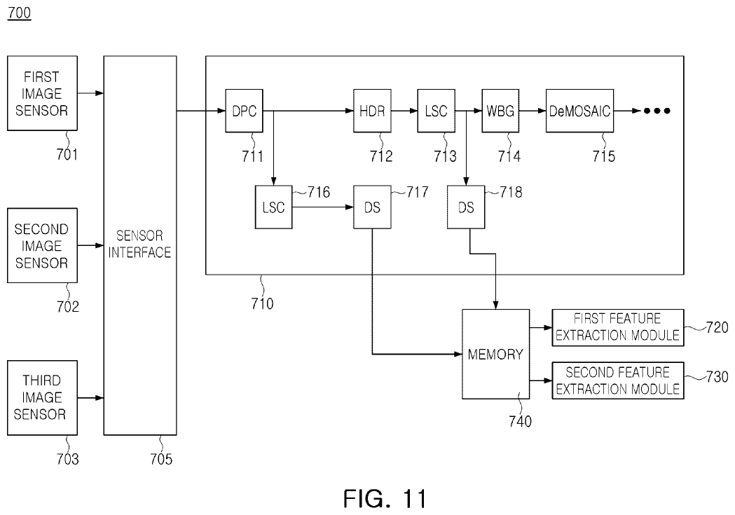

Referring to FIG. 11, an image sensor device 700 according to an example implementation of the present disclosure may include a plurality of image sensors 701 to 703, a sensor interface 705, and an image signal processor 710. A process of generating image data by performing image processing on raw data generated by at least one of the plurality of image sensors 701 to 703 by the image signal processor 710 may be similar to that described above with reference to FIG. 9.

Referring to FIG. 11, a first feature extraction module 720 extracting first feature data from raw data and a second feature extraction module 730 extracting second feature data from HDR data may be implemented separately from the image signal processor 710. Additionally, the first feature extraction module 720 and the second feature extraction module 730 may receive raw data and HDR data from the image signal processor 710 through a memory 740.

Meanwhile, the image signal processor 710 may further include downscalers 717 and 718. The first downscaler 717 may reduce the resolution of the raw data for which lens shading correction is completed and store the same in the memory 740. The second downscaler 718 may reduce the resolution of the HDR data for which lens shading correction is completed and store the same in the memory 740. The first feature extraction module 720 and the second feature extraction module 730 may extract feature data from the raw data and HDR data having the reduced resolution. Accordingly, the time required for the task of extracting the feature data may be shortened.

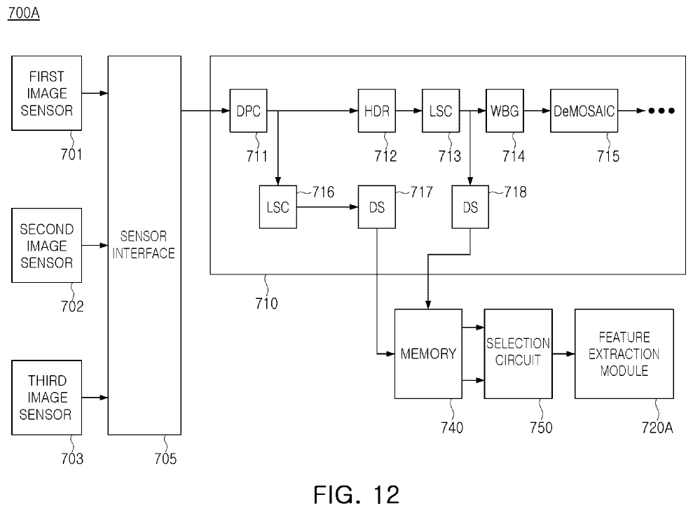

Next, referring to FIG. 12, an image sensor device 700A according to an example implementation of the present disclosure may include only one feature extraction module 720A. A selection circuit 750 may be connected between the memory 740 and the feature extraction module 720A, and the selection circuit 750 may select one of the raw data having the lowered resolution and the HDR data having the lowered resolution, and may input the selected one to the feature extraction module 720A.

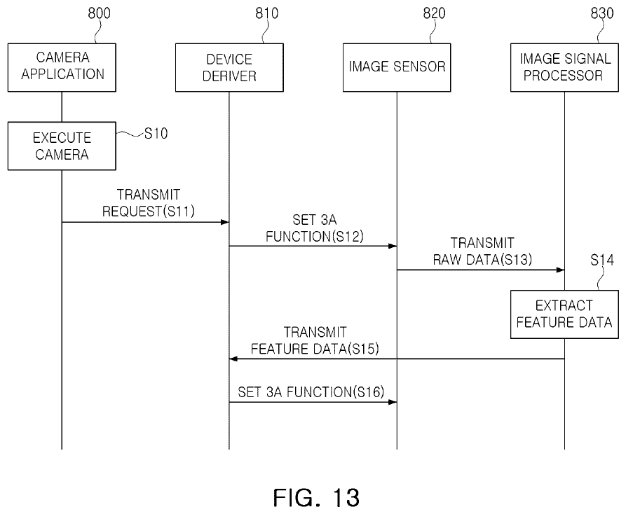

FIG. 13 is a view illustrating an operation of an image sensor device according to an example implementation of the present disclosure.

Referring to FIG. 13, the operation of the image sensor device according to an example implementation of the present disclosure may begin with an execution of a camera function in a camera application 800 of a system equipped with the image sensor device (S10). As the camera function is executed by the camera application 800 driven on the user interface level of the system, the camera application 800 may transmit a request for activating n camera operation to a device driver 810 (S11). The device driver 810 may operate in a separate processor from an image signal processor 830 and may include an image sensor 820 and camera control software driving the image signal processor 830.

The device driver 810 may set a 3A function for the image sensor 820 in response to the request of step S11 (S12). The 3A function may include an autoexposure function, an autofocus function, and an auto white balance function, and may be a function of optimizing an exposure, a focus, and a white balance of the image sensor 820 without user intervention by the image sensor device. A setting of operation S12 may be performed by a pre-stored default value. For example, the device driver may load a default value pre-stored in a register of the image signal processor 830, and may automatically set an exposure time of the image sensor 820, a position and a size of a focused region, and a white balance thereof.

Then, when an imaging operation is performed in the system, the image sensor 820 may generate raw data and transmit the raw data to the image signal processor 830 (S13). The image signal processor 830 may image process the raw data to generate image data, which is RGB data, and may extract feature data (S14). In operation S14, the image signal processor 830 may extract feature data of each of the raw data received from the image sensor 820, and the HDR data generated by processing the raw data by the image signal processor 830.

The feature data extracted by the image signal processor in operation S14 may be transmitted to a device driver 810 (S15). The camera control software of the device driver 810 may set the 3A function in the image sensor 820 by referring to the feature data (S16). For example, an exposure time of the image sensor 820, an aperture value of a lens unit disposed in a path through which light enters the image sensor 820, a gain value of the image sensor 820, and the like, may be adjusted in operation S16. According to an example implementation, an image processing operation of affecting the 3A function may be adjusted not only in the image sensor 820 but also in the image signal processor 830. For example, a gain value reflected in the raw data and/or the HDR data for the white balance adjustment in the image signal processor 830 may be adjusted in operation S16.

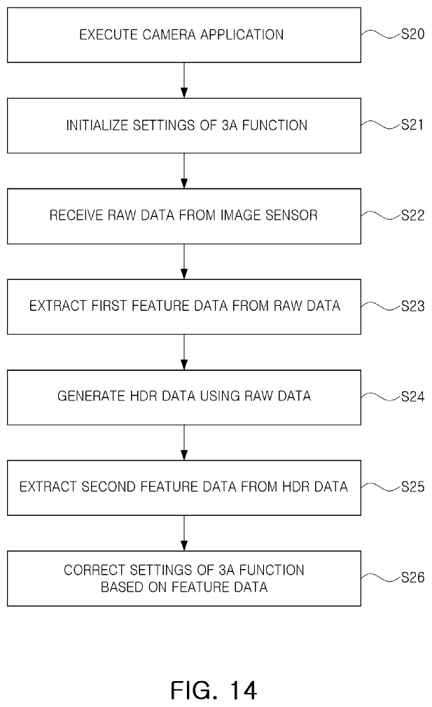

FIG. 14 is a view illustrating an operation of an image sensor device according to an example implementation of the present disclosure.

First, referring to FIG. 14, an operation of the image sensor device according to an example implementation of the present disclosure may begin with a camera application performing a camera function (S20). When the camera function is performed, the camera control software controlling the image sensor device may initialize settings of the 3A function (S21). For example, in operation S21, an exposure time of the image sensor, a conversion gain value of each pixel included in the image sensor, a white balance gain value of an image signal processor, and the like, may be set to pre-stored default values.

When an imaging operation is performed in the camera function, the image sensor may generate raw data, and the image signal processor may receive the raw data from the image sensor (S22). The image signal processor may extract first feature data from the raw data (S23), and an operation of extracting the first feature data in operation S23 may be executed by the feature extraction module. According to an example implementation, the feature extraction module may be implemented as hardware separate from the image signal processor.

While the feature extraction module extracts the first feature data, the image signal processor may generate HDR data using the raw data (S24). As described above with reference to FIGS. 5, 9 to 12, the feature extraction module may extract first feature data by loading the raw data from a signal processing path through which the image signal processor generates the HDR data using the raw data. Accordingly, an operation of generating the HDR data using the raw data and an operation in which the feature extraction module extracts the first feature data from the raw data may be executed simultaneously, and the feature extraction module may quickly acquire the first feature data without delaying the operation of the image sensor device.

When the HDR data is generated, the feature extraction module may extract the second feature data from the HDR data (S25). The image signal processor may perform a DeMosaicing operation on the HDR data, which is in a format such as Bayer data, such as raw data, and convert the data into image data, which is RGB data. As described with reference to FIGS. 5, 9 to 12, the feature extraction module may extract second feature data by loading the HDR data independently from the image signal processor performing the DeMosaicing operation. Accordingly, the feature extraction module may quickly acquire the second feature data without delaying an operation of the image sensor device.

The camera control software may correct the settings of the 3A function based on the first feature data and the second feature data (S26). For example, the camera control software may modify at least one of the exposure time of the image sensor, the conversion gain value of each pixel included in the image sensor, and the white balance gain value of the image signal processor.

The image sensor included in the image sensor device may support the HDR function in various manners. For example, the image sensor may operate in a multiple exposure method of setting a plurality of different exposure times and generating a plurality of pieces of raw data. At the same time that the image signal processor may generate the HDR data using the plurality of pieces of raw data generated in a multi-exposure manner, the feature extraction module may perform an operation of acquiring first feature data from each of the plurality of pieces of raw data, and an operation of acquiring second feature data from the HDR data. In an example implementation, the image sensor may generate the raw data by performing a readout operation two or more times while changing a conversion gain value of each pixel during one exposure time.

As described above, in example implementations of the present disclosure, the operation of extracting the first feature data and the second feature data may be performed in an On-The-Fly manner together with the operation of processing the raw data. Accordingly, the delay in the operation of processing the raw data to generate image data may be minimized to extract the feature data, and the 3A function may be quickly adjusted and optimized.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. An image sensor device, comprising:
an image sensor configured to generate raw data;
an image signal processor including a high dynamic range (HDR) circuit, the HDR circuit configured to generate HDR data using the raw data and process the HDR data to generate image data; and
a feature extraction circuit configured to extract feature data from the raw data and the HDR data,
wherein the image sensor and the image signal processor are configured to
receive a control signal that is based on the feature data, and
adjust, in response to the control signal, at least one of an autoexposure function, an autofocus function, or an auto white balance function.

2. The image sensor device of claim 1,
wherein a plurality of image pixels in each of the raw data and the HDR data have a same color arrangement as a plurality of pixels in a pixel array of the image sensor.

3. The image sensor device of claim 1,
wherein the feature extraction circuit includes:
a first feature extraction circuit configured to extract first feature data from the raw data; and
a second feature extraction circuit configured to extract second feature data from the HDR data.

4. The image sensor device of claim 3,
wherein the first feature extraction circuit is separate from the image signal processor, and the second feature extraction circuit is in the image signal processor.

5. The image sensor device of claim 1, comprising:
a selection circuit configured to select one of the raw data or the HDR data and input the selected one to the feature extraction circuit.

6. The image sensor device of claim 5, comprising:
a memory configured to receive the HDR data from the image signal processor and store the HDR data,
wherein the selection circuit is configured to select one of the HDR data stored in the memory or the raw data.

7. The image sensor device of claim 1, comprising:
a memory configured to
receive the raw data and the HDR data from the image signal processor, and
store the raw data and the HDR data,
wherein the feature extraction circuit is configured to extract first feature data from the raw data stored in the memory and extract second feature data from the HDR data stored in the memory.

8. The image sensor device of claim 7,
wherein the image signal processor includes a downscaler configured to reduce resolution of the raw data and resolution of the HDR data, and
wherein the image signal processor is configured to store, in the memory, the raw data and the HDR data that have reduced resolution.

9. The image sensor device of claim 1,
wherein the feature extraction circuit is configured to generate Autoexposure (AE) feature data from each of the raw data and the HDR data, and
wherein the AE feature data includes at least one of (i) a red-green-blue-yellow (RGBY) histogram of each of the raw data and the HDR data, or (ii) brightness data based on a plurality of regions that are defined in each of the raw data and the HDR data.

10. The image sensor device of claim 9,
wherein the feature extraction circuit is configured to extract autofocus (AF) feature data, the AF feature data including sharpness of a target region in each of the raw data and the HDR data.

11. A system, comprising:
an image sensor configured to image a subject and generate raw data;
an image signal processor configured to convert the raw data into image data;
a driver configured to, in response to a imaging command from a user interface that indicates driving a camera application, drive the image sensor and the image signal processor; and
a feature extraction circuit configured to extract feature data from each of the raw data and high dynamic range (HDR) data, wherein the image signal processor is configured to generate the HDR data based on the raw data,
wherein the driver is configured to set, based on the feature data, an autoexposure, autofocus and auto white balance (3A) function.

12. The system of claim 11,
wherein each of a plurality of image pixels in each of the raw data and the HDR data includes a single color data, and
wherein a color arrangement of the plurality of image pixels is based on a color arrangement of pixels in a pixel array of the image sensor.

13. The system of claim 11,
wherein the feature extraction circuit is in the image signal processor.

14. The system of claim 11,
wherein the feature extraction circuit is separate from the image signal processor.

15. The system of claim 11,
wherein the image signal processor includes a first lens shading correction circuit configured to correct lens shading of the HDR data, and a second lens shading correction circuit configured to correct lens shading of the raw data.

16. The system of claim 15,
wherein the feature extraction circuit includes a first feature extraction circuit configured to extract first feature data from the raw data with corrected lens shading, and a second feature extraction circuit configured to extract second feature data from the HDR data with corrected lens shading.

17. The system of claim 15,
wherein the image signal processor includes a first downscaler configured to reduce resolution of the raw data with corrected lens shading, and a second downscaler configured to reduce resolution of the HDR data with corrected lens shading.

18. The system of claim 11, comprising:
a memory configured to store the feature data,
wherein the driver is configured to read the feature data stored in the memory and set the 3A function.

19. An image sensor device, comprising:
an image sensor configured to generate raw data;
an image signal processor connected to the image sensor via a sensor interface, the image signal processor configured to execute high dynamic range (HDR) processing on the raw data to generate HDR data, the HDR data having a same domain as the raw data; and
a feature extraction circuit configured to generate, based on at least the HDR data, feature data for setting an autoexposure, autofocus and auto white balance (3A) function.

20. The image sensor device of claim 19,
wherein the feature extraction circuit is configured to generate, based on the raw data, first feature data for setting the 3A function, and generate, based on the HDR data, second feature data for setting the 3A function.
